(19) United States
(12) Patent Application Publication
(10) Pub. No.: US 2024/0092140 A1
(43) Pub. Date: Mar. 21, 2024

(54) METHOD FOR DETERMINING AN OUTPUT TEMPERATURE OF A FLUID

(71) Applicant: MAHLE INTERNATIONAL GMBH, Stuttgart (DE)

(72) Inventors: Guillaume DAUDON, La Bourgonce (FR); Timo HENKE, Kernen/Rommelshausen (DE); Florian LEFEVRE, Andolsheim (FR); Jean-Francois WALTER, Turckheim (FR)

(21) Appl. No.: 18/368,135

(22) Filed: Sep. 14, 2023

(30) Foreign Application Priority Data
Sep. 16, 2022 (EP) 22196164.2

(51) Int. Cl. B60H 1/00; G01K 1/022; G01K 13/024

(52) U.S. Cl. CPC B60H 1/00585; B60H 1/00428; G01K 1/022; G01K 13/024; G01K 2205/04

(57) ABSTRACT

The invention relates to a method for determining an output temperature of a fluid after flowing through a PTC heater with a PTC heating element. In the method a current of the PTC heating element, a supply voltage of the PTC heating element and a duty cycle of the supply voltage are determined, and the output temperature of the fluid is calculated based on the current (I), the supply voltage and the duty cycle (PWM). The invention also relates to a PTC heater for carrying out the method.

### CROSS-REFERENCE TO RELATED APPLICATION

This application claims priority from European Patent Application Number 22196164.2, filed on Sep. 16, 2022, the entirety of which is hereby incorporated by reference herein.

The invention relates to a method for determining an output temperature of a fluid after flowing through a PTC heater heating the fluid with a PTC heating element according to the generic term of claim 1. The invention also relates to the PTC heater comprising the PTC heating element for carrying out the method.

A PTC heater (PTC: Positive Temperature Coefficient) comprises at least one PTC heating element made of PTC ceramic and two electrical contacts. The PTC heater can be used to heat a fluid—for example air—in a vehicle air conditioning system. To generate the electrical heating power, a supply voltage is applied to the PTC heating element via the electrical contacts, thereby generating a current in the PTC heating element. By adjusting the supply voltage—for example by means of pulse width modulation—the electrical heating power of the PTC heating element and correspondingly of the PTC heater can be regulated. The electrical heating power is thereby adjusted depending on the required output temperature of the fluid. For this purpose, the output temperature of the fluid has to be determined and is usually measured by means of temperature sensors. Disadvantageously, it can be complex and cost-intensive.

EP 3 672 360 A1 describes a method for controlling the PTC heater depending on the current temperature of the PTC heating element. Here, in particular, overheating of the PTC heater should be prevented.

It is therefore the task of the invention to provide an improved or at least alternative embodiment for a method for determining an output temperature of a fluid, in which the described disadvantages are overcome. It is also the task of the invention to provide a corresponding PTC heater for carrying out the method.

This task is solved according to the invention by the object of independent claims. Advantageous embodiments are the subject of the dependent claims.

The present invention is based on the general idea of determining the output temperature of a fluid without any temperature measurements. In particular, the output temperature is to be determined only by means of the information available in the control unit, such as supply voltage, current, duty cycle of the supply voltage and predetermined constant quantities.

The method according to the invention is designed or provided for determining an output temperature of a fluid after flowing through a PTC heater heating the fluid. The PTC heater contains at least one PTC heating element. In the method, a current of the PTC heater, a supply voltage of the PTC heater, and a duty cycle of the supply voltage are determined. Then, the output temperature of the fluid is calculated based on the current, the supply voltage, and the duty cycle of the supply voltage.

The current and the supply voltage can be measured at the PTC heating element. The supply voltage is a constant DC voltage which is pulse width modulated with the duty cycle. The duty cycle of the supply voltage is specified by a control unit and can be read out from the control unit. The control unit can be a component of the PTC heater. The PTC heating element is contacted in the PTC heater in such a way that the supply voltage can be applied to the PTC heating element. The PTC heating element is formed from a PTC ceramic and is a PTC thermistor. The electrical resistance of the PTC heating element depends on its temperature and vice versa. The PTC heating element thus exhibits a temperature-dependent electrical resistance and can be characterized via a temperature-resistance-characteristic curve. The PTC heater can also have several PTC heating elements.

In the method, the output temperature of the fluid is calculated based on the current, the supply voltage and the duty cycle of the supply voltage. In particular, the output temperature of the fluid can be calculated independently of an input temperature of the fluid prevailing at the input of the PTC heater i.e. before flowing through a PTC heater. The output temperature of the fluid can be calculated without a measurement of temperatures prevailing in the PTC heater and/or in the fluid. The output temperature of the fluid can be calculated exclusively based on the supply voltage, the duty cycle of the supply voltage, and current with the addition of a predetermined characterization constant of the PTC heater. The characterization constant of the PTC heater is constant and can be determined i.e. calculated in preliminary tests.

The output temperature of the fluid can be calculated exclusively from an electrical heating power of the PTC heating element, a temperature prevailing at the PTC heating element and a characterization constant of the PTC heater. Here, the output temperature T_{OUT} of the fluid can be calculated as a difference of a temperature T_{CERAMIC} prevailing at the PTC heating element and a double quotient of the electrical heating power P_{EL} of the PTC heater by the characterization constant K·S of the PTC heater. In other words, the following equation applies:

$${T}_{O U T} = {T}_{C E R A M I C} - 2 \frac{{P}_{E L}}{K \cdot S} .$$

The characterization constant K·S is constant and is a product of an area S and a factor K. The area S indicates the heat transferring surface of the PTC heater which is flowed around by the fluid and the factor K indicates an electrical heating power per surface per Kelvin transmitted by the PTC heating element to the fluid. Thus, the area S is given in m² and the factor K in W/Km². The characterization constant K·S is thus given in W/K. The electrical heating power P_{EL} is given in W and temperatures in ° C.

The following reasoning is used to derive the equation given above. In the PTC heater, a thermal power Q is transferred from the PTC heater to the fluid. In the steady state of the PTC heater, the thermal power Q is identical to the electrical heating power P_{EL} of the PTC heater. In other words, in the steady state of the PTC heater, the generated electrical heating power P_{EL} of the PTC heater is completely transferred as the thermal power Q to the fluid. For the thermal power Q and also for the electrical heating power P_{EL}, the following equation applies in general:

Q=P_{EL}=K·S·ΔT.

The fluid has an inlet temperature T_{IN} when it flows into the PTC heater and an outlet temperature T_{OUT} when it flows out of the PTC heater. Assuming that the PTC heating element changes its temperature during the applying of the electrical heating power P_{EL}, the PTC heating element has a temperature T_{IN,PTC} before the electrical heating power P_{EL} is applied and a temperature T_{OUT,PTC} after the electrical heating power P_{EL} is applied. The following equation applies then for the temperature gradient ΔT:

$$Δ T = \frac{{T}_{IN , PTC} + {T}_{OUT , PTC}}{2} - \frac{{T}_{I N} + {T}_{OUT}}{2} .$$

In the steady state of the PTC heater, it can be assumed that the temperature T_{IN,PTC} of the PTC heating element is identical to the input temperature T_{IN} of the fluid and the temperature T_{OUT,PTC} is identical to the temperature T_{CERAMIC} prevailing at the PTC heating element. Then the temperature gradient ΔT can be simplified as follows:

$$Δ T = \frac{{T}_{I N} + {T}_{C E R A M I C}}{2} - \frac{{T}_{I N} + {T}_{OUT}}{2} = \frac{{T}_{C E R A M I C} - {T}_{OUT}}{2} .$$

The thermal power Q or the electrical heating power P_{EL} are then given by the following equation:

$$Q = {P}_{E L} = K \cdot S \cdot \frac{{T}_{C E R A M I C} - {T}_{OUT}}{2} .$$

This equation leads to the equation already given above for the output temperature T_{OUT} of the fluid:

$${T}_{O U T} = {T}_{C E R A M I C} - 2 \frac{{P}_{E L}}{K \cdot S} .$$

The electrical heating power P_{EL} of the PTC heater can thereby be calculated as a product of the supply voltage U, the duty cycle PWM of the supply voltage U and the current I. In other words, the following equation applies:

P_{EL}=U·I·PWM.

As described above, the current I and the supply voltage U can be measured at the PTC heater i.e. the PTC heating element and the duty cycle PWM of the supply voltage U can be read out from a control unit. The duty cycle PWM can vary between 0% and 100%. The supply voltage is applied to the PTC heating element 100% of the time when PWM=100% and 0% of the time when PWM=0%. Accordingly, the PTC heater generates the maximum heating power of 100% when PWM=100% and the minimum heating power of 0% i.e. zero when PWM=0%. The supply voltage U is specified in V and the current I in A. The electrical heating power P_{EL} is specified in W.

As explained above, the characterization constant K·S of the PTC heater can be given as a product of the area S and the factor K. Here, the area S is the surface of the PTC heater that is flowed around by the fluid and is contacted to the fluid in a heat-transferring manner. In other words, the area S is the surface of the PTC heater by means of which the PTC heater can transfer heat to the fluid. The factor K indicates the electrical heating power per surface per Kelvin transmitted i.e. given up by the PTC heater to the fluid. The area S and the factor K are constant and consequently the characterization constant K·S is constant. The area S and the factor K depend on the geometry of the PTC heater and may differ for different PTC heaters. The area S and the factor K can be determined i.e. calculated by preliminary tests on the respective PTC heater.

The temperature T_{CERAMIC} of the PTC heating element i.e. prevailing at the PTC heating element can be determined or calculated in different ways. In the first alternative, an electrical resistance R_{CERAMIC} of the PTC heating element can be calculated from the supply voltage U and the current I. The following equation applies:

$${R}_{CERAMIC} = \frac{U}{I} .$$

The electrical resistance R_{CERAMIC} is thus specified in Ω. Then, the temperature T_{CERAMIC} of the PTC heating element i.e. prevailing at the PTC heating element can be read out from a predetermined matrix or table depending on i.e. as a function of the supply voltage U and the electrical resistance R_{CERAMIC} of the PTC heating element.

The temperature T_{CERAMIC} can be read out from a predetermined matrix or table. The matrix may contain the variables associated with each other such as the supply voltage U, the electrical resistance R_{CERAMIC}, the temperature T_{CERAMIC} and a frequency f of the duty cycle PWM of the supply voltage U. Thus, the matrix may be of the form {f, U, R_{CERAMIC}, T_{CERAMIC}}. The matrix may be of the form {U, R_{CERAMIC}, T_{CERAMIC}} if the frequency f is fixed or of the form {f, R_{CERAMIC}, T_{CERAMIC}} if the supply voltage U is fixed or of the form {R_{CERAMIC}, T_{CERAMIC}} if the frequency f and the supply voltage U are fixed. The matrix can be determined i.e. calculated by preliminary tests, where the corresponding electrical resistances R_{CERAMIC} and the corresponding temperatures T_{CERAMIC} are calculated i.e. determined and/or read out from known reference works for the deviating possible supply voltages U of the PTC heating element. The matrix can especially be determined during characterization of the PTC heating element. For this purpose, measurements of the output temperature T_{OUT} of the fluid can be made to link the electrical resistances R_{CERAMIC} with the temperature T_{CERAMIC} of the PTC heating element following the reverse equation

$${T}_{CERAMIC} = {T}_{O U T} + 2 \frac{{P}_{E L}}{K \cdot S} .$$

The calculated output temperature T_{OUT} of the fluid can be output to a user in the method. Alternatively or additionally, the calculated output temperature T_{OUT} of the fluid can be compared with a predetermined limit temperature T_{THRESHOLD}. When the limit temperature T_{THRESHOLD} is exceeded, the electrical heating power P_{EL} can be reduced and the method can be continued. When the limit temperature T_{THRESHOLD} is not exceeded, the method can be continued without the reducing of the electrical heating power P_{EL}. In this way, temperatures in the fluid above the limit temperature T_{THRESHOLD} and thus overheating of the fluid can be prevented.

In the method, the above-mentioned calculation/determination of the relevant quantities—such as the supply voltage U and/or the duty cycle PWM of the supply voltage U and/or the current I and/or the electrical heating power P_{EL} and/or the electrical resistance R_{CERAMIC} and/or the temperature T_{CERAMIC} prevailing at the PTC heating element and/or the output temperature T_{OUT} of the fluid—can be carried out in a control unit. The above-mentioned quantities used for the calculation/determination—such as the characterization constant K·S and/or the matrix {f, U, R_{CERAMIC}, T_{CERAMIC}} and/or the limit temperature T_{THRESHOLD}— can be stored or pre-stored in the control unit and used as required. The characterization constant K·S and/or the matrix {f, U, R_{CERAMIC}, T_{CERAMIC}} can be determined i.e. calculated in preliminary tests for the present PTC heater. Known reference works can also be used to determine the matrix {f, U, R_{CERAMIC}, T_{CERAMIC}}. In particular, the control unit can be an integral part of the PTC heater.

The invention also relates to a PTC heater with at least one PTC heating element. The PTC heater can be flowed through by a fluid and is provided or designed to heat the fluid to the output temperature T_{OUT} by means of the PTC heating element. The PTC heater is thereby provided or designed to carry out the method described above. For carrying out the method, the PTC heater can in particular comprise the control unit described above. To avoid repetition, reference is made at this point to the above explanations.

Further important features and advantages of the invention are apparent from the subclaims, from the drawings, and from the accompanying figure description based on the drawings.

It is understood that the above features and those to be explained below can be used not only in the combination indicated in each case, but also in other combinations or on their own, without departing from the scope of the present invention.

Preferred embodiments of the invention are shown in the drawings and will be explained in more detail in the following description, wherein identical reference signs refer to identical or similar or functionally identical components.

It shows, each schematically

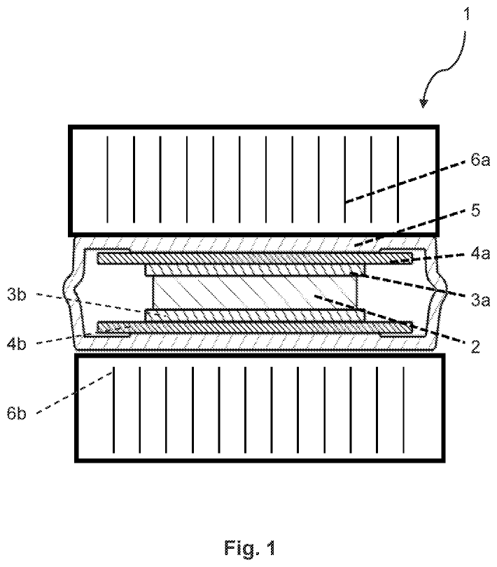

FIG. 1 a sectional view of a PTC heater with a PTC heating element according to the invention;

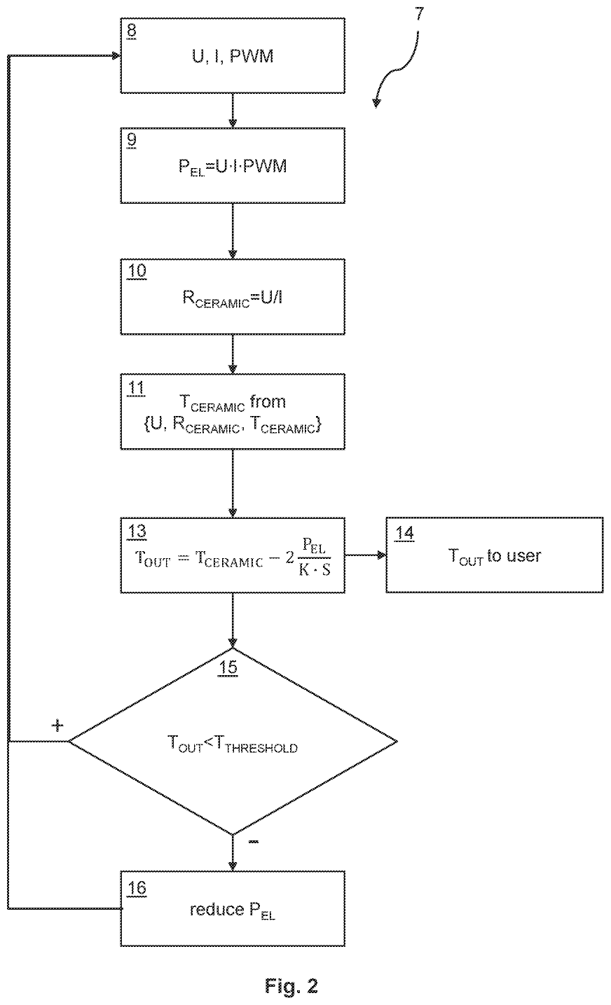

FIG. 2 a schematic diagram of a method according to the invention.

FIG. 1 is a sectional view of a PTC heater 1 according to the invention. The PTC heater 1 comprises a PTC heating element 2 made of a PTC ceramic, two electrical conductive contact plates 3a and 3b, two dielectrical insulating plates 4a and 4b, a housing 5 made of a thermally conductive material such as metal, and two ribs 6a and 6b made of a thermally conductive material such as metal. The PTC heating element 2 is arranged between the contact plates 3a and 3b and is in electrical conductive contact therewith. The insulating plates 4a and 4b are arranged on the contact plates 3a and 3b facing away from the PTC heating element 2. The housing encloses the PTC heating element 2, the contact plates 3a and 3b and the insulating plates 4a and 4b. The insulating plates 4a and 4b are arranged between the housing 5 and the contact plates 3a and 3b and insulate the contact plates 3a and 3b from the housing 5. The ribs 6a and 6b are arranged on the outside of the housing 5. The ribs 6a and 6b are connected to the housing 5 in a heat-transferring manner, and the housing 5 is connected to the PTC heating element 2 in a heat-transferring manner via the insulating plates 4a and 4b and the contact plates 3a and 3b. The PTC heating element 2, the contact plates 3a and 3b, the insulating plates 4a and 4b, the housing 5, and the ribs 6a and 6b are suitably fixed to each other. The PTC heater 1 also contains a control unit for controlling the PTC heating element 2, but the control unit is not shown here.

The control unit of the PTC heater 1 can apply a supply voltage U to the PTC heating element 2 via the contact plates 3a and 3b. The supply voltage U is a DC voltage and can be pulse width modulated with a variable duty cycle PWM. Current I flows then in the PTC heating element 2 and the PTC heating element 2 generates an electrical heating power P_{EL}. The PTC heating element 2 heats up to a temperature T_{CERAMIC} depending on the applied supply voltage U i.e. the duty cycle PWM of the supply voltage U. The PTC heating element 2 has an electrical resistance R_{CERAMIC} depending on the temperature T_{CERAMIC} due to its PTC properties. A fluid can flow around the ribs 6a and 6b and can be heated by the PTC heater 1 i.e. the PTC heating element 2 from an input temperature to an output temperature T_{OUT}. The PTC heater 1 is characterized by an area S and a factor K. The area S is the heat-transferring surface of the PTC heater 1 flowed around by the fluid, and the factor K is the electrical heating power transferred by the PTC heater 2 to the fluid per surface per Kelvin. The area S and the factor K are constant for the given PTC heater 1.

FIG. 2 shows a schematic diagram of a method 7 according to the invention for determining the output temperature T_{OUT} of the fluid after flowing through the PTC heater 1. The method 7 is carried out by the PTC heater 1 for example via the control unit of the PTC heater 1.

In the method 7, the supply voltage U, the current I and the duty cycle PWM of the supply voltage U are determined in a step 8. The supply voltage U and the current I can be measured at the PTC heating element 2. The duty cycle PWM is a controlled variable of the PTC heater 1 and can be read out from the control unit.

Then, in a step 9, the electrical heating power P_{EL} of the PTC heater 1 is calculated using the equation:

P_{EL}=U·I·PWM.

Then, the temperature T_{CERAMIC} prevailing at the PTC heating element 2 is determined. Thereby, in the step 10, the electrical resistance R_{CERAMIC} of the PTC heating element 2 is calculated using the equation:

$${R}_{CERAMIC} = \frac{U}{I} .$$

Subsequently, in a step 11, the temperature T_{CERAMIC} of the PTC heating element 2 is read out from a predetermined matrix {U, R_{CERAMIC}, T_{CERAMIC}} as a function of the previously measured supply voltage U. The matrix {U, R_{CERAMIC}, T_{CERAMIC}} is originally of the form {f, U, R_{CERAMIC}, T_{CERAMIC}}, wherein the frequency f of the duty cycle PWM of the supply voltage U is constant. The matrix {U, R_{CERAMIC}, T_{CERAMIC}} i.e. {f, U, R_{CERAMIC}, T_{CERAMIC}} can be determined i.e. calculated in preliminary tests and/or read out from known reference works and can be stored in the control unit of the PTC heater 1.

After determining the temperature T_{CERAMIC} of the PTC heating element 2, in a step 13 the output temperature T_{OUT} of the fluid is calculated using the equation:

$${T}_{O U T} = {T}_{C E R A M I C} - 2 \frac{{P}_{E L}}{K \cdot S} .$$

There, a constant characterization constant K·S of the PTC heater 1 is used. The characterization constant K·S is given by a constant area S and a constant factor K. The area S is a heat-transferring surface of the PTC heater 1 flowed around by the fluid. The factor K is an electrical heating power transmitted by the PTC heating element 2 to the fluid per surface per Kelvin. The area S and the factor K can be determined by preliminary tests on the respective PTC heater 1 and stored in the control unit of the PTC heater 1.

Then, the calculated output temperature T_{OUT} of the fluid is output to a user in a step 14 and compared to a limit temperature T_{THRESHOLD} in a step 15. If the output temperature T_{OUT} is greater than the limit temperature T_{THRESHOLD}, the heating power P_{EL} is reduced. For this purpose, the duty cycle PWM of the supply voltage U can be reduced up to zero. Then the method 7 is continued with the step 8. If the output temperature T_{OUT} is lower than the limit temperature T_{THRESHOLD}, the method 7 is continued with the step 8 without the step 16.

The specification is understood with reference to the following Numbered Paragraphs:
Numbered Paragraph 1. A Method (7) for determining an output temperature (T_{OUT}) of a fluid after flowing through a PTC heater (1) heating the fluid with a PTC heating element (2), wherein in the method:
   a current (I) of the PTC heating element (2), a supply voltage (U) of the PTC heating element (2) and a duty cycle (PWM) of the supply voltage (U) are determined, and
   the output temperature (T_{OUT}) of the fluid is calculated based on the current (I), the supply voltage (U) and the duty cycle (PWM).
Numbered Paragraph 2. Method according to Numbered Paragraph 1, characterized
   in that the output temperature (T_{OUT}) of the fluid is calculated independently of an input temperature of the fluid before flowing through a PTC heater (1), and/or
   in that the output temperature (T_{OUT}) of the fluid is calculated without a measurement of temperatures prevailing in the PTC heater (1) and/or in the fluid, and/or
   in that the output temperature (T_{OUT}) of the fluid is calculated exclusively based on the supply voltage (U), the duty cycle (PWM) of the supply voltage (U) and the current (I) with the addition of a predetermined characterization constant (K·S) of the PTC heater (1).
Numbered Paragraph 3. Method according to Numbered Paragraph 1 or 2,
   characterized in that the output temperature (T_{OUT}) of the fluid is calculated exclusively from an electrical heating power (P_{EL}) of the PTC heating element (2), a temperature (T_{CERAMIC}) prevailing at the PTC heating element (2) and a characterization constant (K·S) of the PTC heater (1).
Numbered Paragraph 4. Method according to Numbered Paragraph 3,
   characterized in that the electrical heating power (P_{EL}) of the PTC heating element (2) is calculated as a product of the supply voltage (U), the duty cycle (PWM) of the supply voltage (U) and the current (I).
Numbered Paragraph 5. Method according to Numbered Paragraph 3 or 4,
   characterized in that, when calculating the output temperature (T_{OUT}) of the fluid, an electrical resistance (R_{CERAMIC}) of the PTC heating element (2) is calculated from the supply voltage (U) and the current (I).
Numbered Paragraph 6. Method according to any one of Numbered Paragraphs 3 to 5,
   characterized in that, when calculating the output temperature (T_{OUT}) of the fluid, the temperature (T_{CERAMIC}) prevailing at the PTC heating element (2) is read out from a predetermined matrix ({f, U, R_{CERAMIC}, T_{CERAMIC}}) depending on the supply voltage (U), the frequency (f) of the duty cycle (PWM) of the supply voltage (U) and the calculated electrical resistance (R_{CERAMIC}) of the PTC heating element (2).
Numbered Paragraph 7. Method according to any one of Numbered Paragraphs 3 to 6,
   characterized in that the characterization constant (K·S) of the PTC heater (1) is a product of a heat-transferring area (S) of the PTC heater (1) which is flowed around by the fluid and a factor (K) which indicate an electrical heating power per surface per Kelvin transmitted by the PTC heating element (2) to the fluid.
Numbered Paragraph 8. Method according to any one of Numbered Paragraphs 3 to 7,
   characterized in that the output temperature (T_{OUT}) of the fluid is calculated as a difference of the temperature (T_{CERAMIC}) prevailing at the PTC heating element (2) and a double quotient of the electrical heating power (P_{EL}) of the PTC heater (1) by the characterization constant (K·S) of the PTC heater (1).
Numbered Paragraph 9. Method according to any one of the preceding Numbered Paragraphs,
   characterized
   in that the output temperature (T_{OUT}) of the fluid is compared with a predetermined limit temperature (T_{THRESHOLD}), wherein the electrical heating power (P_{EL}) is reduced and the method (7) is continued when the limit temperature (T_{THRESHOLD}) is exceeded, and wherein the method (7) is continued without the reducing of the electrical heating power (P_{EL}) when the limit temperature (T_{THRESHOLD}) is not exceeded, and/or
   in that the output temperature (T_{OUT}) of the fluid is output to a user.
Numbered Paragraph 10. PTC heater (1) with a PTC heating element (2), wherein the PTC heater (1) can be flowed through by a fluid and is provided for heating the fluid to an output temperature (T_{OUT}), characterized in that the PTC heater (1) is provided for carrying out the method (7) according to one of the preceding Numbered Paragraphs.

1. A Method for determining an output temperature of a fluid after flowing through a PTC heater heating the fluid with a PTC heating element,
wherein in the method:
a current of the PTC heating element, a supply voltage of the PTC heating element and a duty cycle of the supply voltage are determined, and
the output temperature of the fluid is calculated based on the current, the supply voltage and the duty cycle.

2. The method according to claim 1, wherein:
the output temperature of the fluid is calculated independently of an input temperature of the fluid before flowing through a PTC heater, and/or
the output temperature of the fluid is calculated without a measurement of temperatures prevailing in the PTC heater and/or in the fluid, and/or
the output temperature of the fluid is calculated exclusively based on the supply voltage, the duty cycle of the supply voltage and the current with the addition of a predetermined characterization constant of the PTC heater.

3. The method according to claim 1, wherein the output temperature of the fluid is calculated exclusively from an electrical heating power of the PTC heating element, a temperature (T_{CERAMIC}) prevailing at the PTC heating element and a characterization constant (K·S) of the PTC heater.

4. The method according to claim 3, wherein the electrical heating power of the PTC heating element is calculated as a product of the supply voltage, the duty cycle of the supply voltage and the current.

5. The method according to claim 3, wherein when calculating the output temperature of the fluid, an electrical resistance (R_{CERAMIC}) of the PTC heating element is calculated from the supply voltage and the current.

6. The method according to claim 3, wherein when calculating the output temperature of the fluid, the temperature (T_{CERAMIC}) prevailing at the PTC heating element is read out from a predetermined matrix ({f, U, R_{CERAMIC}, T_{CERAMIC}}) depending on the supply voltage, the frequency of the duty cycle of the supply voltage and the calculated electrical resistance (R_{CERAMIC}) of the PTC heating element.

7. The method according to claim 3, wherein the characterization constant (K·S) of the PTC heater is a product of a heat-transferring area of the PTC heater which is flowed around by the fluid and a factor which indicate an electrical heating power per surface per Kelvin transmitted by the PTC heating element to the fluid.

8. The method according to claim 3, wherein the output temperature of the fluid is calculated as a difference of the temperature (T_{CERAMIC}) prevailing at the PTC heating element and a double quotient of the electrical heating power (P_{EL}) of the PTC heater by the characterization constant (K·S) of the PTC heater.

9. The Method according to claim 1, wherein:
the output temperature of the fluid is compared with a predetermined limit temperature (T_{THRESHOLD}), wherein the electrical heating power (P_{EL}) is reduced and the method is continued when the limit temperature (T_{THRESHOLD}) is exceeded, and wherein the method is continued without the reducing of the electrical heating power (P_{EL}) when the limit temperature (T_{THRESHOLD}) is not exceeded, and/or
the output temperature of the fluid is output to a user.

10. A PTC heater with a PTC heating element, wherein the PTC heater can be flowed through by a fluid and is provided for heating the fluid to an output temperature (T_{OUT}), characterized in that the PTC heater is provided for carrying out the method according to claim 1.
